(19) United States
(12) Patent Application Publication
(10) Pub. No.: US 2016/0378201 A1
(43) Pub. Date: Dec. 29, 2016

(54) DYNAMIC ALTERATION OF INPUT DEVICE PARAMETERS BASED ON CONTEXTUALIZED USER MODEL

(71) Applicant: INTERNATIONAL BUSINESS MACHINES CORPORATION, ARMONK, NY (US)

(72) Inventors: AARON K. BAUGHMAN, GAITHERSBURG, MD (US); JAMES R. KOZLOSKI, YORKTOWN HEIGHTS, NY (US); TIMOTHY LYNAR, MELBOURNE (AU); SURAJ PANDEY, CARLTON (AU); JOHN WAGNER, MELBOURNE (AU)

(21) Appl. No.: 14/752,125

(22) Filed: Jun. 26, 2015

(51) Int. Cl. G06F 3/03; G06F 3/041

(52) U.S. Cl. CPC G06F 3/03; G06F 3/0416

(57) ABSTRACT

A method for dynamically altering computer input device parameters based on a contextualized user model, including measuring environmental factors that effect a user's input device, monitoring a user's historical use of a computing device to determine the user's input device parameters, using environmental factors and user's input device parameters to parameterize a cognitive model for the user and expected state transitions, using the cognitive model to predict optimal settings of the user input devices, and comparing the predicted optimal settings to desired user interface modifications, and adjusting the input device to generate these modifications.

### TECHNICAL FIELD

This disclosure is directed dynamically configurable computer input devices.

### DISCUSSION OF THE RELATED ART

Currently, computer input devices, such as a mouse, a touchpad, a keyboard, etc., are configured statically based on direct user input, or by the selection of a profile or accessibility setting. In other words, the settings do not vary until reconfigured. Even in cases where the configuration is learned through use of the devices, for example in accessibility scenarios, the configuration is static once set. Dynamically changing a user interface and the cognitive-physical relationship parameters based upon a cognitive model over time has not been exploited in the prior art. Information such as the time of day, the time spent computing, can condition cognitive model parameters that vary with time, such as fatigue, attentiveness, precision, etc., and may be used to modify user input device parameters, such as double click speed, mouse speed, scroll speed, etc. Some users experience a degradation of fine motor skills as fatigue increases. In addition, on a monitor, the screen brightness, font size, and color can change as a user becomes fatigued. The degradation of fine motor skill due to fatigue and age has been the subject of much research.

### SUMMARY

Exemplary embodiments of the disclosure as described herein generally include systems and methods that can model a user and a user's current behavior while using the input device to dynamically change the input device settings to optimize a user's current use of the input device.

According to an embodiment of the disclosure, there is provided a method for dynamically altering computer input device parameters based on a contextualized user model, including measuring environmental factors that effect a user's input device, monitoring a user's historical use of a computing device to determine the user's input device parameters, using environmental factors and user's input device parameters to parameterize a cognitive model for the user and expected state transitions, using the cognitive model to predict optimal settings of the user input devices, and comparing the predicted optimal settings to desired user interface modifications, and adjusting the input device to generate these modifications.

According to another embodiment of the disclosure, there is provided a non-transitory program storage device readable by a computer, tangibly embodying a program of instructions executed by the computer to perform the method steps for dynamically altering computer input device parameters based on a contextualized user model.

### BRIEF DESCRIPTION OF THE DRAWINGS

FIG. 1 is a flow chart of a method for dynamically altering input device parameters based on a contextualized user model, according to an embodiment of the disclosure.

FIG. 2 depicts a cloud computing node according to an embodiment of the present disclosure.

FIG. 3 depicts a cloud computing environment according to an embodiment of the present disclosure.

FIG. 4 depicts abstraction model layers according to an embodiment of the present disclosure.

### DETAILED DESCRIPTION OF EXEMPLARY EMBODIMENTS

Exemplary embodiments of the disclosure as described herein generally include methods for dynamically altering input device parameters based on a contextualized user model. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

Embodiments of the disclosure can create contextualized user models based on user actions or behaviors, user history and user information. As the user uses an input device, a model of the user can be built by examining the various characteristics of input device usage, such as double click speed, mouse speed, scroll speed, etc., and other information, such as how long the user has been using the computer, time of day, day of week, etc., that relate to input device use. This model is augmented with data on the user's state, such as emotion, fatigue, attentiveness, precision, etc., discerned via not only the input device usage but also the content of any user input. The construction and use of such models from the data is known in the art.

Exemplary embodiments of the present disclosure can provide and use of a model of a user's cognitive state and current behavior while using a computer input device to dynamically change the input device settings to optimize the user's current use of the input device. For example, when the user's fine motor skills decline due to fatigue, a method according to an embodiment of the disclosure can model that behavior and use that model to adjust input device settings.

Exemplary embodiments of the present disclosure can parameterize a contextualized user cognitive model based on environmental measures, historical data, and other direct measures of a user to dynamically adjust setting for computer input devices. These can affect model outputs when it is simulated. According to embodiments of the disclosure, simulation results are used to adjust input device parameters to optimize the device's accessibility to the user in a given cognitive state.

According to a further embodiment of the disclosure, the user's historical use of a computing device is constantly monitored and recorded.

According to a further embodiment of the disclosure, the user's activity is monitored and recorded, and includes time spent typing, time spent mousing, and time spent reading, changes in pressure, acceleration, motion, speed, anomalous movement, abuse of the device by the user, repeated attempts to change configuration, and changes in skin luminescence.

According to a further embodiment of the disclosure, the user's input device parameters include input speed, tempo, and response time.

According to a further embodiment of the disclosure, environmental factors include time of day and background noise.

According to a further embodiment of the disclosure, the method includes adjusting user input devices according to the predict optimal settings, where setting include touch responsiveness of key presses on a touchscreen keyboard, mouse tracking rates, and double click speeds.

According to a further embodiment of the disclosure, the cognitive model includes one or more state-machines.

According to a further embodiment of the disclosure, the method includes receiving user reactions to input device adjustments made based on the cognitive model predicted optimal settings, where user reactions include re-adjustments and reversals of the adjustments.

A model according to an embodiment of the disclosure can be used to dynamically alter the settings of the input device as the user's cognitive state changes, not in a one-off manner, but any time the user's cognitive state changes. Moreover, a contextualized user cognitive model according to an embodiment of the disclosure is agnostic to the user's physical state, applies to all computer users, and optimizes for their cognitive state independent of their physical state. In addition, model according to an embodiment of the disclosure works at an operating system level and therefore has access to other inputs to estimate a user's cognitive state, such as a calendar, and has access to the settings for all input devices, which may be adjusted automatically and dynamically based on these estimates.

A contextualized user cognitive model according to an embodiment of the disclosure can adapt/adjust to various cognitive-motor changes in the user over the course of a day, such as low motor skills or response early in the day, or after fatigue has set in. This automatic adjustment can involve the tolerance surrounding key presses on a touchscreen keyboard, mouse tracking rates, or double click speeds.

A slider interface is typically used to adjust touch responsiveness, double click speed, etc. A model according to an embodiment of the disclosure can be used to perform these adjustments automatically to adjust touch sensitivity, double click speed, etc. of the user interface to enhance user performance and maximize effectiveness and speed of use, given the current cognitive-motor state of the user.

According to an embodiment of the disclosure, there are several ways to detect a user's frustration or bad affordances, including changes in pressure, acceleration, motion, speed, anomalous movement, abuse of the device by the user, repeated attempts to change configuration, even changes in skin luminescence detected by a video camera, etc. User frustration can also be detected by examining and comparing the statistics, such as mean, standard deviation, distribution, etc., of the use of the input device before and after changes. According to an embodiment of the disclosure, anything that can be measured—in this case frustration—can be used as an objective function and therefore be minimized.

According to an embodiment of the disclosure, reinforcement learning can be used to disambiguate user interface affordances and to determine what is most important to a user, sensitivity or specificity. When a user becomes frustrated, sensitivity thresholds can be decreased when applying machine learning models. When a person becomes frustrated at the lack of device changes, precision is decreased and sensivity is increased. Embodiments of the disclosure can also revert changes to explicitly signal frustration or bad affordances, e.g. a user can actively punish a change with a revert button, indicate acceptance levels via a slider bar or like/dislike buttons, etc.

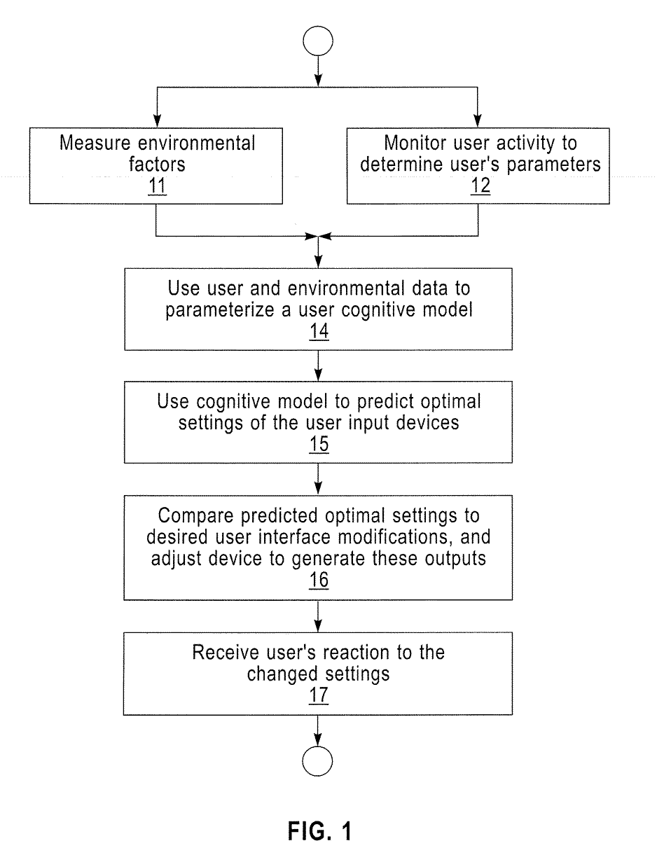

FIG. 1 is a flow chart of a method for dynamically altering input device parameters based on a contextualized user cognitive model, according to an embodiment of the disclosure. Referring now to the figure, a method starts at step 11 by measuring environmental factors, such as time of day, background noise, etc., that can effect a user's input device. At step 12, a user's historical use of the computing device, such as time spent typing, time spent mousing, time spent reading, etc., are measured. According to embodiments of the disclosure, user activity will be constantly monitored and recorded. Parameters, such as input speed, tempo, response time, etc. can be determined from such recording. The data acquired at steps 11-12 is used at step 14 to parameterize a model of the user's cognitive state and expected state transitions. Then, at step 15, the model developed at step 14 is used to predict optimal settings of the user input devices, which are adjust accordingly. A computer model of the cognitive state of the individual according to an embodiment of the disclosure can be described by one or many state- machines. Such models fall under the field of cognitive state assessment. Some devices will have known optimal settings for a given user types/operation modes, while others will require machine learning or other learning systems to determine optimal settings.

For example, an increase in erroneous input of some devices may be limited through adjustment of settings. The onset of an increase in erroneous input may be determined by a user's cognitive state. Examples include driving, mouse movement etc. At step 16, the predicted optimal settings are compared to a prediction of desired user interface modifications, and the device is adjusted to generate these outputs given the predicted inputs. At step 17, the user's reaction can be received as described above, in which a user can reverse the changes, or make readjustments to the predicted optimal settings.

It is understood in advance that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

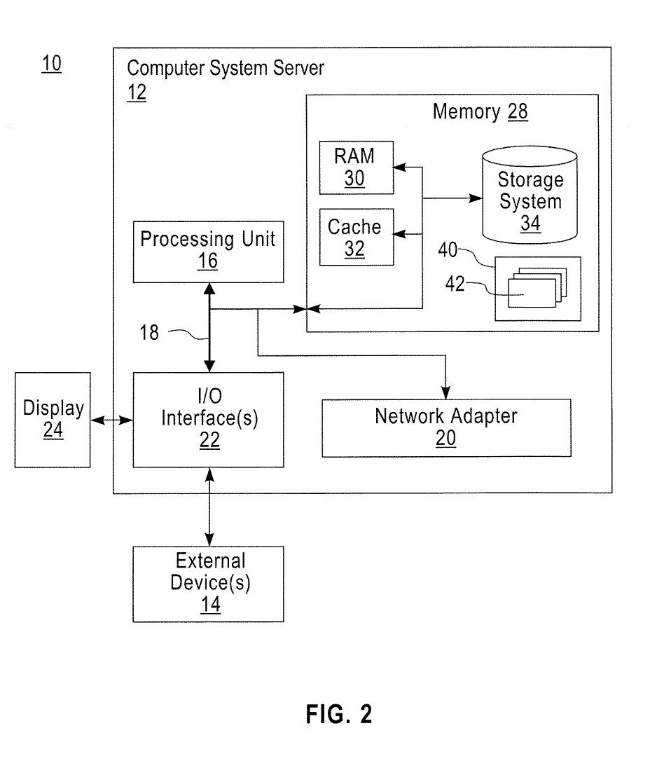

Referring now to FIG. 2, a schematic of an example of a cloud computing node is shown. Cloud computing node 10 is only one example of a suitable cloud computing node and is not intended to suggest any limitation as to the scope of use or functionality of embodiments of the disclosure described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 2, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus,

Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the disclosure as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

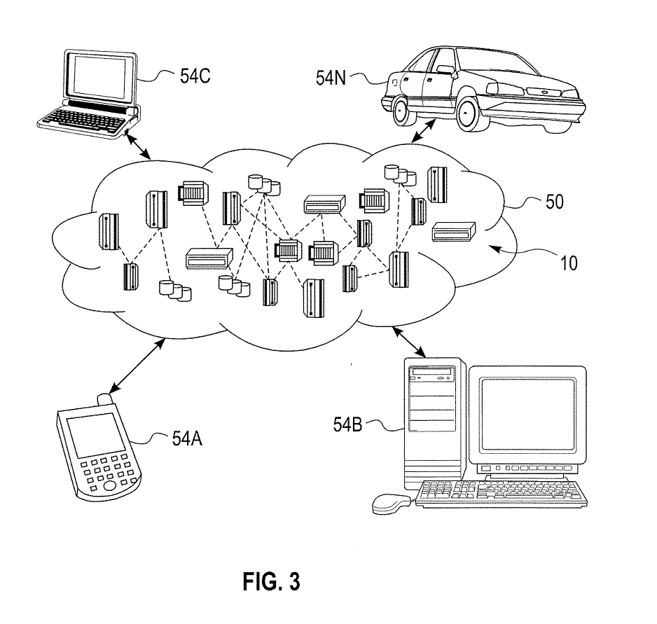

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

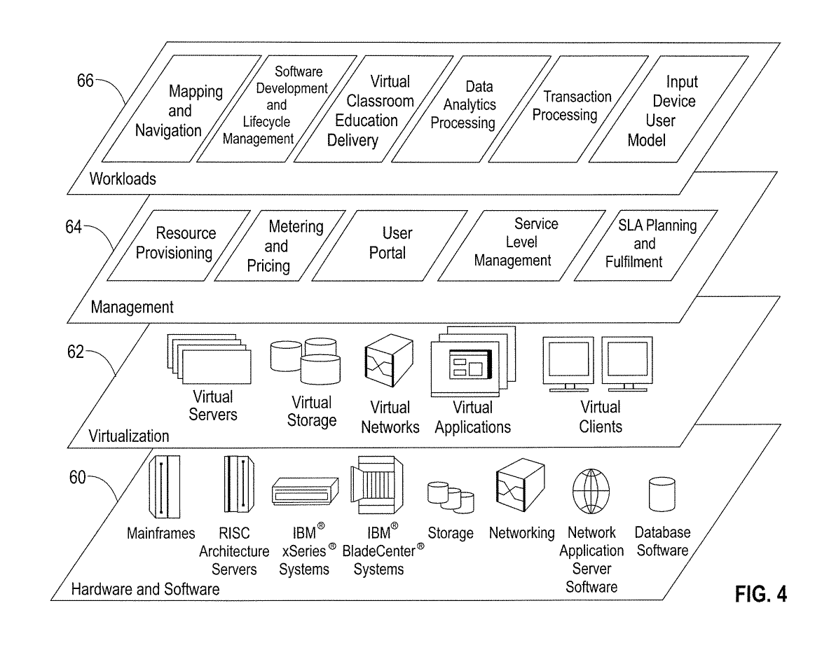

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the disclosure are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks; virtual applications and operating systems; and virtual clients. In one example, management layer 64 may provide the functions described below.

Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing; and dynamically altering input device parameters based on a contextualized user model.

While the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for dynamically altering computer input device parameters based on a contextualized user model, comprising the steps of:
measuring environmental factors that effect a user's input device;
monitoring a user's historical use of a computing device to determine the user's input device parameters;
using environmental factors and user's input device parameters to parameterize a cognitive model for the user and expected state transitions;
using the cognitive model to predict optimal settings of the user input devices; and
comparing the predicted optimal settings to desired user interface modifications, and adjusting the input device to generate these modifications.

2. The method of claim 1, wherein the user's historical use of a computing device is constantly monitored and recorded.

3. The method of claim 2, wherein the user's activity is monitored and recorded, and includes time spent typing, time spent mousing, and time spent reading, changes in pressure, acceleration, motion, speed, anomalous movement, abuse of the device by the user, repeated attempts to change configuration, and changes in skin luminescence.

4. The method of claim 1, wherein the user's input device parameters include input speed, tempo, and response time.

5. The method of claim 1, wherein environmental factors include time of day and background noise.

6. The method of claim 1, further comprising adjusting user input devices according to the predict optimal settings, wherein setting include touch responsiveness of key presses on a touchscreen keyboard, mouse tracking rates, and double click speeds.

7. The method of claim 1, wherein the cognitive model includes one or more state-machines.

8. The method of claim 1, further comprising receiving user reactions to input device adjustments made based on the cognitive model predicted optimal settings, wherein user reactions include re-adjustments and reversals of said adjustments.

9. A non-transitory program storage device readable by a computer, tangibly embodying a program of instructions executed by the computer to perform the method steps for dynamically altering computer input device parameters based on a contextualized user model, the method comprising the steps of:
measuring environmental factors that effect a user's input device;
monitoring a user's historical use of a computing device to determine the user's input device parameters;
using environmental factors and user's input device parameters to parameterize a cognitive model for the user and expected state transitions;
using the cognitive model to predict optimal settings of the user input devices; and
comparing the predicted optimal settings to desired user interface modifications, and adjusting the input device to generate these modifications.

10. The computer readable program storage device of claim 9, wherein the user's historical use of a computing device is constantly monitored and recorded.

11. The computer readable program storage device of claim 10, wherein the user's activity is monitored and recorded, and includes time spent typing, time spent mousing, and time spent reading, changes in pressure, acceleration, motion, speed, anomalous movement, abuse of the device by the user, repeated attempts to change configuration, and changes in skin luminescence.

12. The computer readable program storage device of claim 9, wherein the user's input device parameters include input speed, tempo, and response time.

13. The computer readable program storage device of claim 9, wherein environmental factors include time of day and background noise.

14. The computer readable program storage device of claim 9, further comprising adjusting user input devices according to the predict optimal settings, wherein setting include touch responsiveness of key presses on a touchscreen keyboard, mouse tracking rates, and double click speeds.

15. The computer readable program storage device of claim 9, wherein the cognitive model includes one or more state-machines.

16. The computer readable program storage device of claim 9, further comprising receiving user reactions to input device adjustments made based on the cognitive model predicted optimal settings, wherein user reactions include re-adjustments and reversals of said adjustments.
